(19) United States
(12) Patent Application Publication
(10) Pub. No.: US 2018/0095011 A1
(43) Pub. Date: Apr. 5, 2018

(54) Apparatus for Taking Samples from a Slurry Flow

(71) Applicant: GEKKO SYSTEMS PTY LTD, Mount Waverley, Victoria (AU)

(72) Inventor: Alexander Hamilton LEWIS-GRAY, Ballarat (AU)

(21) Appl. No.: 15/553,154

(22) PCT Filed: Feb. 15, 2016
(86) PCT No.: PCT/AU2016/000039

§ 371 Date: Aug. 23, 2017

(30) Foreign Application Priority Data
Feb. 26, 2015 (AU) 2015900676

(51) Int. Cl. G01N 1/20; G01N 9/02

(52) U.S. Cl. CPC G01N 1/2035; G01N 2001/2071; G01N 9/02

(57) ABSTRACT

In one form of the present invention is an apparatus that is capable of periodically diverting at least a portion of a slurry flow from a processing facility and collecting it into a container, such as a bucket. The volume and weight of the collected sample can then be ascertained, and the bulk density of the sample can be derived, and the bulk density data can then be sent via wired or wireless communication means to the processing facility so that they can take steps to alter the characteristics of the slurry flow. In another form, of the present invention, the periodically collected sample from the slurry flow is collected via the apparatus for subsequent analysis in a laboratory.

### FIELD OF THE INVENTION

This invention relates to a flow sampler. It relates particularly but not exclusively to samplers used for sampling flowable slurries from mining operations.

### BACKGROUND OF THE INVENTION

In the mining industry, flows containing valuable materials such as ores, precious metals, coal, gems, etc. are generated by mining equipment crushing the material being mined and forming it into slurries which can be subjected to various enhancement operations. The fact that the flows are in the form of a slurry generally makes it easy to transport between various items of equipment by pumping and can also facilitate the actual operations of concentrating or separating the valuable materials from the slurry.

In order to optimize mining and treatment, it may be necessary to monitor the characteristics of the flow to determine the most appropriate areas to mine, the optimum treatment conditions and to measure the output of product from the mine.

However, in practice, it has been found difficult to obtain accurate samples of the flow on a regular basis. For example, it may be difficult to obtain an accurate reading of the density of the flow because it may contain particulate material of various dimensions ranging front the relatively large to the very fine. Furthermore, because of the sheer volume of flow generated in mining operations, it can prove difficult to obtain a representative sample of an entire flow as the characteristics of the flow may vary over a cross-section of the flow.

The current invention seeks to provide a flow sampler which has advantages over current flow sampling processes and apparatus.

### SUMMARY OF THE INVENTION

The invention provides in one aspect an apparatus for sampling a slurry flow including, a housing a conduit arranged to direct a flow of slurry into the housing, and an open mouth arranged to receive slurry delivered from the conduit when the open mouth and conduit are in alignment, and a motorized transport assembly arranged to change the relative locations of the conduit and open mouth, and a collection point. The motorized transport assembly can periodically align and misalign the relative positions of the conduit and the open mouth, thereby enabling samples of the slurry flow to be periodically diverted through the open mouth and into the collection point.

Preferably the conduit is arranged so as to drop the slurry flow into the housing, and the open mouth is arranged so that, the slurry flow dropping into the housing, falls into the open mouth, when the two are in alignment.

Optionally the open mouth is dimensioned so that it extends across the entire width of shim flowing from the conduit, or it is dimensioned so as to take only a slice of flow across the total flow width.

Preferably the motorized transport assembly moves the conduit from a rest position so that it passes over the open mouth, and the open mouth is shaped and dimensioned so that it is adapted to collect the entire slurry flow that is delivered from the conduit.

Preferably the open mouth is in the shape of a slot with parallel sides.

Preferably the transport assembly returns the conduit back to the rest positon by moving it past the open mouth in the opposite direction.

Preferably the motorized transport assembly includes controls that automatically move the conduit periodically in order to obtain samples from the slurry flow periodically.

Preferably there are at least two separate collection points.

Preferably one of the collection points includes a chute communicating with the mouth and extending outside of the housing, and the chute is arranged to feed the sample material into a hopper, or conduit, for testing of the contents of the sample material in an environment such as laboratory.

Preferably one of the collection points includes a bucket arranged within the housing, and the bucket is associated with weighing means that are adapted to weigh the sample collected in the bucket.

Preferably depth measuring means are included that are adapted to measure the depth of the sample contained Within the bucket.

Preferably the depth measuring means includes a device that utilizes a laser beam or RADAR, and the instrument is suspended from a position above the bucket, and the depth measurement data is combinable with the weight of the sample collected in the bucket to determine the bulk density of the sample collected in the bucket.

Preferably logic control means are included, and the logic control means are capable of determining the bulk density of the sample collected in the bucket, and electronically communicating that information across a wired or wireless network, to a processing facility from which the sample from the slurry flow was obtained, so that the information can be used to alter the operating parameters for the processing facility so that the characteristics of the slurry flow coming from the facility are altered.

Preferably means are included that are adapted to measure the time taken to fill the bucket with a sample.

Preferably the logic control means are capable of receiving the fill time information and using that to calculate the mass or volume flow rate of the slurry flow.

Alternatively, there are at least two open mouths included in the apparatus, and each is capable of periodically receiving slurry flow from the conduit.

Preferably the motorized transport includes controls for automatically moving the conduit periodically over any one of or all of, the open mouths, in order to obtain separate samples from the slurry flow periodically.

Preferred aspects of the invention will now be described with reference to the accompanying drawings.

### BRIEF DESCRIPTION OF THE DRAWINGS

FIG. 1 is an axonometric view of a sampler according to the invention;

FIG. 2 is an exploded view of components forming the sampler of FIG. 1;

FIG. 3 is a partial x-ray elevational view of the sampler of FIG. 1;

FIG. 4 is a plan view of the sampler of FIG. 1;

FIG. 5 is an elevational view of the sampler of FIG. 3 rotated clock clockwise through 90°; and

FIG. 6 shows an elevational view of the sampler of FIG. 3 rotated clockwise through 270°.

### DESCRIPTION OF THE PREFERRED EMBODIMENT

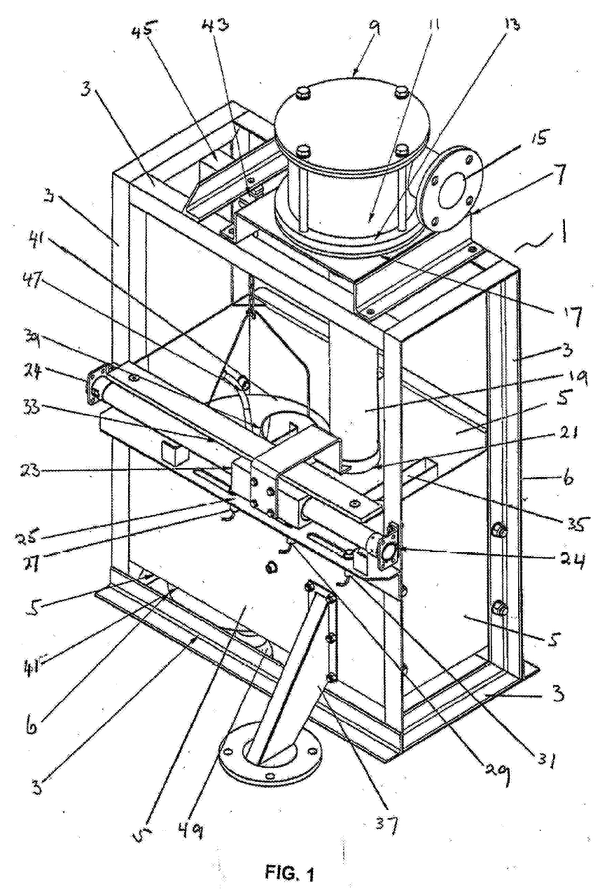

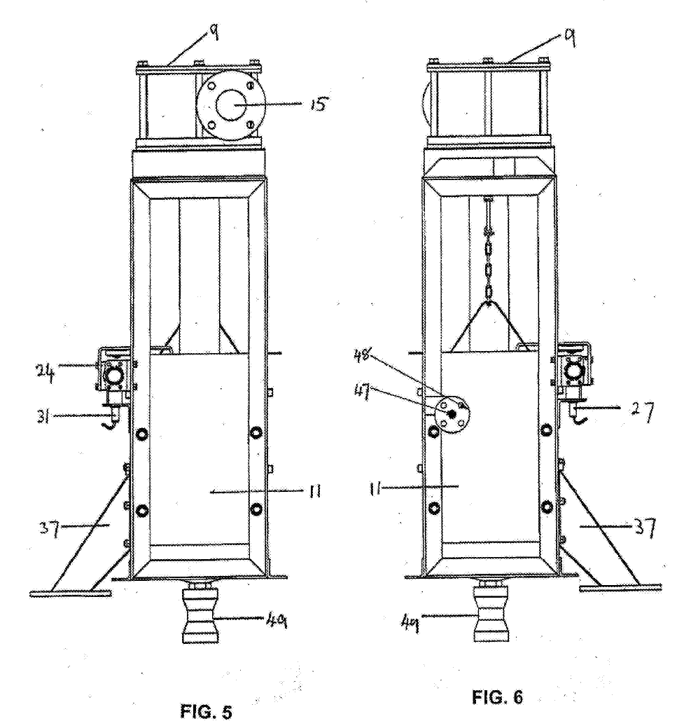

Referring to FIGS. 1 to 6 of the accompanying drawings, there is shown a flow sampler according to the invention generally designated 1.

The flow sampler comprises a frame 3 having an open bottom 4.

Side walls 5 extending from a lower point of the frame to a higher position roughly intermediate the height of the frame extend around the inside of the frame. The frame and side walls in combination define a housing generally designated 6.

A mounting base 7 is secured to the top of the frame in the manner illustrated.

The mounting base serves to mount the blind cyclone 9. A circular base 13 is provided on the bottom of the blind cyclone.

The blind cyclone includes a circular side wall 11 which acts to swirl a flow of slurry fed into the blind cyclone via the inlet 15.

A clamp 17 attaches the circular base 13 to the mounting base 7.

A conduit 19 extends through the mounting base 7 and communicates with the interior of the blind cyclone. The bottom end of the conduit terminates within the housing 6.

The conduit 19 may be in the form of a flexible hose. It is secured at its bottom end by the collar 21.

A linear drive 23 is connected to the collar. It is arranged to move sideways when activated. It moves back and forth along the trackway defined by the nylon slide 33 and is supported by the slide.

Opposite ends of the nylon slide 33 are held by the brackets 24 which attach to the frame 3.

Proximity sensors 27, 29 and 31 are provided on the slotted angle 25 as illustrated, to sense the position of the linear drive 23 as it moves forward and backwards along the nylon slide 33.

An open mouth 35 is positioned in the housing 6 at a location to the right of the rest position of linear drive. It is located at an elevation lower than that of the bottom of the conduit 19. The open mouth 35 is formed as a slot which can take a “slice” of flow across the entire width of the flow. Opposed sides of the open mouth are parallel.

When the linear drive is in its rest position, the arrangement is such that slurry flowing out of the conduit 19 may simply fall through the open bottom 4 of the housing 6 and into a collector such as a hopper positioned below the housing. From there it may be directed for further processing or harvesting.

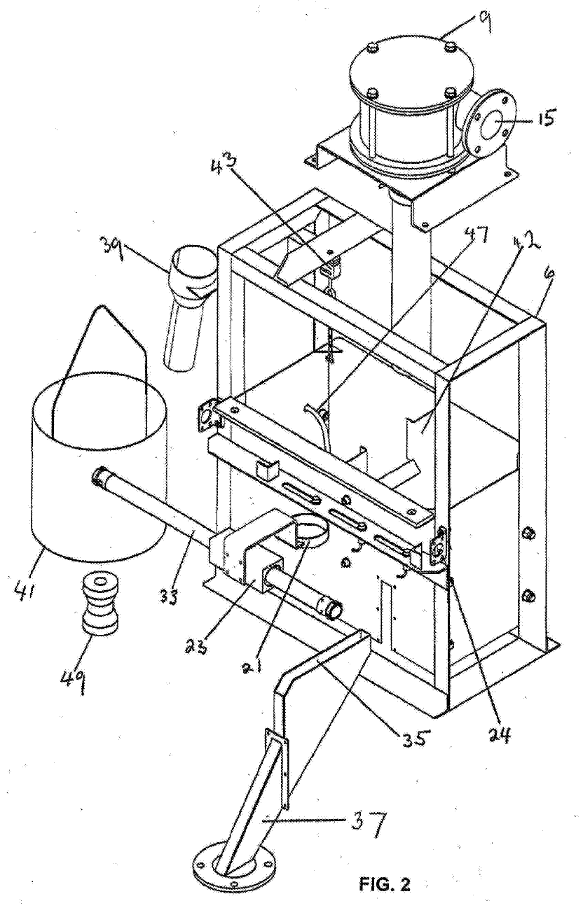

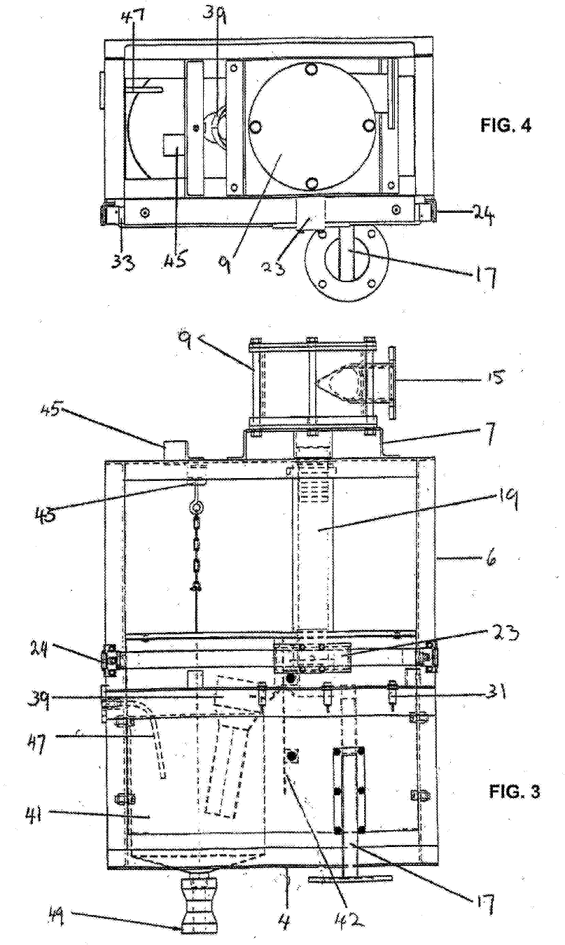

A funnel 19 provided next to the baffle 42, shown more clearly in FIGS. 2 and 3, is to provided in a location to the left of the rest position of the conduit 19. The funnel mouth is at an elevation lower than the conduit. The purpose of the baffle 42 is to act as a splash guard when the conduit is moved to be above and in registry with the funnel to drop sample material into the funnel.

The funnel is arranged to direct flow sampled from the conduit into the hopper 41. The hopper 41 comprises a bucket which is suspended from a load cell 43 mounted on an upper part of the frame.

A laser level sensor 45 is mounted next to the load cell and is positioned to sense the level of sample slurry in the hopper 41. In another preferred embodiment, the laser level sensor 45 can be replaced by a RADAR system, or they can work in tandem.

The bottom of the hopper 41 includes a pinch valve 49 through which the slurry sample may be drained when density readings for the sample have been completed.

A flush line attached to the housing 6, by the flange 48 is provided to flush out the hopper with water when the pinch valve 49 is opened to release the sample.

During normal operation of the sampler 1 described with reference to FIGS. 1 to 6, the sampler will be inserted at an appropriate position of a processing system for a mining operation. For most of the time, the conduit 19 will be maintained in the illustrated rest position shown in the drawings. This is also shown as the rest position for the linear drive 23. In the rest position for the conduit, a slurry flow passes from the inlet 15 through the blind cyclone 9 and down through the conduit 19. It then falls through the open bottom 4 of the housing into a collection facility such as hopper for further processing, etc.

However, periodically, say once every 1 to 60 minutes, the linear drives moves the collar 21 and hence flexible conduit 19 to the left so that it drops slurry into the funnel 39 to be dumped into the hopper 41.

When the laser level sensor 45 senses an appropriate level of sample in the hopper 41, it activates the linear drive 23 to return the collar and hence the outlet of the conduit to the rest position where it can then continue to fall through the housing.

The load cell, gives a reading of the weight of material in the hopper 41. Thus by combining the load cell reading with that of the laser level sensor 45, the density of is sample in the hopper 41 can be calculated and the controlling parameters of the process machinery for producing the flow may be adjusted according to the calculated density levels.

After the density sampling has been completed, the pinch valve 49 opens to allow the sample to flow out of the hopper 41 assisted by flushing liquid provided by the flush line 47.

In order to obtain samples for checking in a remote location such as laboratory, the linear drive 23 moves the conduit to the right so that it passes over the slot shaped opening 35 which forms the mouth for the chute 37.

As the length of the slot mouth 35 is significantly larger than the internal diameter of the conduit 19, and the bottom of the conduit is pushed across the mouth 35, suitably at a constant velocity, a uniform sample is taken across the entire breadth of the flow falling out of the conduit. When the conduit is returned to the rest position, a further uniform sample is taken on the return journey. Thus two “slices” of sample will normally be taken for each forward and back pass.

Samples may typically be taken in this fashion every 60 to 120 minutes. The samples may be dropped from the chute 37 into a receiving vessel for transport to a testing location.

In a further preferred aspect of the present invention, timing means are included that are capable of measuring the time it takes to fill the bucket with a sample of the slurry. The timing information is then passed to the logic control means where it is used to calculate the mass or volume flow rate of the main slurry flow.

While the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise” and variations such as “comprises” and “comprising”, are used in this specification, unless the context requires otherwise such use is intended to imply the inclusion of a stated feature or features but is not to be taken as excluding the presence of other feature or features.

The reference to prior art in this specification is not, and should not be taken as, an acknowledgement or any form of suggestion that such prior art forms part of the common general knowledge.

1. An apparatus for sampling a slurry flow including,
a housing, and
a conduit arranged to direct a flow of slurry into the housing, and
an open mouth arranged to receive slurry delivered from the conduit when the open mouth and conduit are in alignment, and
a motorized transport assembly arranged to change the relative locations of the conduit and open mouth, and
a collection point.
wherein the motorized transport assembly can periodically align and misalign the relative positions of the conduit and the open mouth, thereby enabling samples of the slurry flow to be periodically diverted through the open mouth and into the collection point.

2. An apparatus as defined in claim 1 wherein the conduit is arranged so as to drop the slurry flow into the housing, and the open mouth is arranged so that the slurry flow dropping into the housing, falls into the open mouth, when the two are in alignment.

3. An apparatus as defined in claim 1 wherein the open mouth is dimensioned so that it extends across the entire width of slurry flowing from the conduit, or it is dimensioned so as to take only a slice of the flow across the total flow width.

4. An apparatus as defined in claim 1 wherein the motorized transport assembly moves the conduit from a rest position so that it passes over the open mouth, and the open mouth is shaped and dimensioned so that it is adapted to collect the entire slurry flow that is delivered from the conduit.

5. An apparatus as defined in claim 4 wherein the open mouth is in the shape of a slot with parallel sides.

6. An apparatus as defined in claim 4 wherein the transport assembly returns the conduit back to the rest positon by moving it past the open mouth in the opposite direction.

7. An apparatus as defined in claim 1 wherein the motorized transport assembly includes controls that automatically move the conduit periodically in order to obtain samples from the slurry low periodically.

8. An apparatus as defined in claim 1 wherein there are at least two separate collection points.

9. An apparatus as defined in claim 8 wherein one of the collection points includes a chute communicating with the mouth and extending outside of the housing, and the chute is arranged to feed the sample material into a hopper, or conduit, is for testing of the contents of the sample material in an environment such as laboratory.

10. An apparatus as defined in claim 8 wherein one of the collection points includes a bucket arranged within the housing, and the bucket is associated with weighing means that are adapted to weigh the sample collected in the bucket.

11. An apparatus as defined in claim 10 wherein depth measuring means are included that are adapted to measure the depth of the sample contained within the bucket.

12. An apparatus as defined in claim 11 wherein the depth measuring means includes a device that utilizes a laser beam or RADAR, and the instrument is suspended from a position above the bucket, and the depth measurement data is combinable with the weight of the sample collected in the bucket to determine the bulk density of the sample collected in the bucket.

13. An apparatus as defined in claim 12 wherein logic control means are included, the logic control means are capable of determining the bulk density of the sample collected in the bucket, and electronically communicating that information across a wired or wireless network, to a processing the facility from which the sample from the slurry flow was obtained, so that the information can be used to alter the operating parameters for the processing facility so that the characteristics of the slurry flow coming from the facility are altered.

14. An apparatus as defined in claim 13 wherein timing means are included that are adapted to measure the time taken to fill the bucket with a sample.

15. An apparatus as defined in claim 14 wherein the logic control means are capable of receiving the fill time information from the timing means and using that to calculate the mass or volume flow rate of the slurry flow.

16. An apparatus as defined in claim 1 wherein there are at least two open mouths included, and each is capable of periodically receiving slurry flow from the conduit.

17. An apparatus as defined in either claim 16 wherein the motorized transport includes controls for automatically moving the conduit periodically over any one of, or all of, the open mouths, in order to obtain separate samples from the slurry flow periodically.
